(19) United States
(12) Patent Application Publication
(10) Pub. No.: US 2003/0174440 A1
(43) Pub. Date: Sep. 18, 2003

(54) Disc media retainer

(76) Inventors: Klaus Kloeppel, Watsonville, CA (US); Paco Flores, Felton, CA (US)

Correspondence Address: Brian D. Kaul, WESTMAN CHAMPLIN & KELLY, Suite 1600 - International Centre, 900 South Second Avenue, Minneapolis, MN, 55402-3319, US

(21) Appl. No.: 10/215,633

(22) Filed: Aug. 9, 2002

Related U.S. Application Data
(60) Provisional application No. 60/364,073, filed on Mar. 13, 2002.

(51) Int. Cl. G11B 17/02

(52) U.S. Cl. 360/99.12

(57) ABSTRACT

A disc media retainer used to secure one or more discs to a hub member without applying forces to the discs that could cause them to become warped. The disc media retainer generally includes a disc hub member having an annular flange, a disc supported on the annular flange, and a retaining ring adapted to secure the disc to the hub member. In accordance with one embodiment, the retaining ring is swaged within an annular groove of the disc hub member and a radial gap between the disc hub member and an interior edge of the disc, and over a top surface of the disc adjacent the interior edge of the disc. In accordance with another embodiment, the retaining ring is wedged within the radial gap, welded to the disc hub member, and swaged over a top surface of the disc adjacent the interior edge.

### CROSS-REFERENCE TO RELATED APPLICATION

The present invention claims priority from U.S. Provisional Application No. 60/364,073 filed on Mar. 13, 2002 for inventors Klaus Kloeppel and Paco Flores and entitled “ULTRASONIC WELDED DISK MEDIA RETENTION.”

### FIELD OF THE INVENTION

The present invention relates generally to a disc media retainer for use in disc drive storage systems and external servo writers to secure disc media for rotation about a central axis, and more particularly but not by limitation, to a disc media retainer that secures the disc media to a disc hub member without applying forces to the discs that could cause them to become warped.

### BACKGROUND OF THE INVENTION

Modern computers employ various forms of storage systems for storing programs and data. These storage systems include disc drive systems that operate under the control of a computer to record information and/or retrieve recorded information on one or more recording discs. Such disc drives include hard disc drives which employ recording discs that have magnetizable recording material, optical disc drives which employ recording discs that have optically readable recording material, magneto-optical disc drives which employ recording discs that have optically readable magnetizable recording material, and the like.

Conventional disc drive systems typically include one or more (disc stack) recording discs supported for relatively high speed rotation on a rotary spindle that is driven by a motor. The spindle can be a rotatable shaft or sleeve surrounding a shaft of a fluid dynamic bearing cartridge, for example. The rotatable spindle defines the core of the stack, is cylindrical in shape and serves to align the disc or discs around a common axis. Reading and/or writing heads are positioned adjacent surfaces of the discs for reading data from and/or writing data to circular concentric data tracks.

A disc clamp is used to secure the disc or discs to the spindle. To assure that proper registration of the disc for reading and writing purposes can be achieved, the disc clamp must secure the discs to the spindle to prevent them from dislodging and moving in the axial or radial direction once mounted to the spindle. Thus, the discs must be protected from non-operational shocks that can occur during installation of the disc drive into a computer and during transport of the computer. Additionally, it is desirable that the discs be mounted without deforming the discs since, which adversely affects the reading and writing performance of the heads. Finally, it is desirable that the height required by the disc clamp to mount the discs to the spindle be minimized to meet the never-ending demands for smaller and shorter disc drives.

Current systems utilize a disc clamp to secure the discs in place on the spindle. Conventional disc clamps are available in various configurations. One known type of disc clamp uses screws passed through a circular plate and into tapped openings in the hub to provide the axial load. Unfortunately, the circular plate and screws undesirably add height to the disc stack. In addition, the individual screws produce localized stresses in the discs, which distort the shape of the disc at the inner diameter thereby making it difficult to maintain a uniform fly height of the head.

A second known type of disc clamp includes a bell-shaped part that operates as a spring. Typically, screws are passed through openings in the center of the bell-shaped part and into a tapped opening in the hub. Unfortunately, providing a hub with enough material for a tapped opening requires height. In addition, attaching the screws at the center of the hub causes the bell-shaped part to flatten as the screws are tightened. The edges of the bell-shaped part which contact the disc during tightening move across the surface of the disc in a radially outward direction. The movement of the disc clamp with respect to the disc causes the disc to undesirably distort into a conical shape, and produces a radial load on the disc.

A third known type of disc clamp is a heat-shrink ring which is attached to the top of the hub without the use of screws. This type of disc clamp is often referred to as a shrink-fit disc clamp. A ring is heated so that it expands and the inner diameter of the ring is greater than the outer diameter of the hub. A tool is then used to transfer the heated ring to the top of the disc stack and to apply a clamping force to the heated ring. The clamping force is maintained on the ring as it cools resulting in the application of a substantially uniform axial load to the discs. Unfortunately, mounting of the discs to the drive using such a shrink-fit disc clamp can be complicated and problems with slippage of the ring on the spindle can arise.

As mentioned above, the discs used in disc drives generally include circular data tracks which extend circumferentially around each disc. These data tracks are defined by radially extending servo tracks that contain servo information. The servo information defines the boundaries and centerlines of each of the tracks. Disc drives utilize servo systems to control the position of a read/write head relative to the data tracks using the servo information stored in the servo tracks. As a head moves over a surface of a disc, the head reads the servo information and produces an output signal that indicates its position relative to the servo tracks. The output signal is demodulated and compared with a reference position signal relating to a desired head position to produce a position error signal (PES). The PES is provided to a servo controller that produces a control signal which is used to control an actuator mechanisms of the disc drive or spin-stand to move the head toward the desired position or data track. Once the head is positioned over the desired data track, the servo system allows the head to follow the track using the servo information.

The servo tracks are typically written after the discs have been mounted to the spindle of the disc drive using the disc clamp. These “post-written” tracks are substantially concentric with the axis of rotation of the disc on which they are written, since the axis of rotation remains constant from when the servo information is written to when the servo information is used to perform track following. However, uncontrolled factors such as bearing tolerances, spindle resonances, displacement of the disc due to non-operational shocks, and the like, tend to introduce errors in the location of the servo information. As a result, each track is typically not perfectly concentric with the axis of rotation of the disc, but rather exhibits certain random, repeatable variations which are sometimes referred to as repeatable runout (RRO). This slight misalignment is exhibited in a periodic PES, which can be compensated for using conventional techniques.

There is a continuing trend in the disc drive industry to provide successive generations of disc drive products with ever increasing data storage capacities and data transfer rates. Because the amount of disc surface available for the recording of data remains substantially constant (or even decreases as disc drive form factors become smaller), substantial advancements in areal recording densities, both in terms of the number of bits that can be recorded on each track as well as the number of tracks on each disc (measured as tracks per inch or TPI), are continually being made in order to facilitate such increases in data capacity. One way to improve storage capacities is to improve the writing of the servo patterns on the discs.

To that end, servo information is written on the discs prior to their installation in a disc drive using highly precise servo writers. These “pre-written” tracks can result in a potential increase in the TPI of the disc. Unfortunately, disc drives incorporating discs having these pre-written tracks cannot realize an increase in recording capacity because the encountered RRO is too large to be compensated for using standard techniques. The large RRO is the result of a tremendous eccentricity that exists between the data tracks and the new axis of rotation of the discs that have been installed in the disc drive using conventional disc clamping methods, such as those discussed above.

There exists a never-ending demand for improvements to disc drive performance. To that end, it would be desirable to provide an improved method of securing discs to the spindle of a disc drive or servo writer that avoids application of forces to the discs that could cause their shape to distort.

### SUMMARY OF THE INVENTION

The present invention relates generally to a disc media retainer used to secure one or more discs to a hub member without applying forces to the discs that could cause them to become warped. The disc media retainer generally includes a disc hub member having an annular flange, a disc supported on the annular flange, and a retaining ring adapted to secure the disc to the hub member. In accordance with one embodiment, the retaining ring is swaged within an annular groove of the disc hub member and a radial gap between the disc hub member and an interior edge of the disc, and over a top surface of the disc adjacent the interior edge of the disc. In accordance with another embodiment of the invention, the retaining ring is wedged within the radial gap, welded to the disc hub member, and swaged over a top surface of the disc adjacent the interior edge.

The present invention also facilitates the formation of a disc pack assembly outside of a disc drive or an external servo writer while providing concentric alignment between one or more discs and the hub member during handling. Such a disc pack assembly can have discs with pre-written servo tracks that, when mounted to a spindle of a disc drive, are more concentrically aligned with the axis of rotation of the spindle as compared to when prior art clamping methods are used to mount the pre-written discs to the spindle of the disc drive.

Other features and benefits that characterize embodiments of the present invention will be apparent upon reading the following detailed description and review of the associated drawings.

### BRIEF DESCRIPTION OF THE DRAWINGS

FIG. 1 is an isometric view of a disc drive.

FIGS. 2 and 3 are enlarged side cross-sectional views illustrating a disc retainer in accordance with an embodiment of the invention.

FIG. 4 is a top plan view of a retaining ring in accordance with an embodiment of the invention.

FIGS. 5 and 6 are enlarged side cross-sectional views illustrating a disc retainer in accordance with an embodiment of the invention.

FIGS. 7 and 8 are enlarged side cross-sectional views of disc media retainers that are configured to support multiple discs in accordance with various embodiments of the invention.

### DETAILED DESCRIPTION OF ILLUSTRATIVE EMBODIMENTS

As will be discussed in greater detail below, the disc media retainer of the present invention utilizes a retaining ring to secure a disc to a disc hub member. The disc hub member can be a rotatable spindle hub of a disc drive or servo writer that is rotated by a motor. Alternatively, the disc hub member can be a primary disc supporting component of a disc pack assembly that is mountable to the spindle hub of a disc drive or servo writer for co-rotation therewith. To simplify the discussion of the invention, the term “disc hub member” as used herein is intended to describe all of these components.

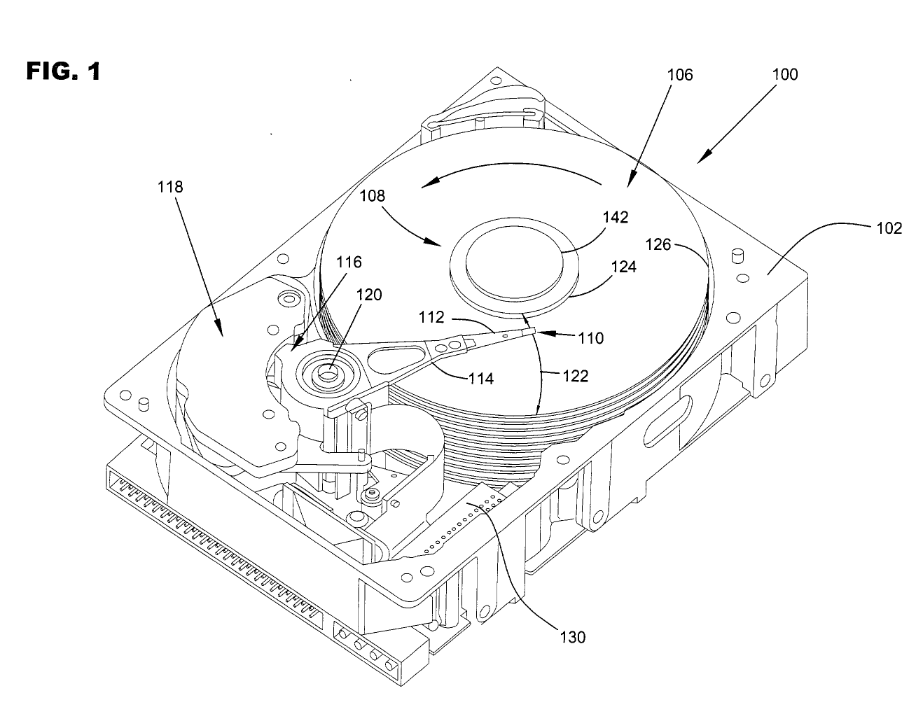

FIG. 1 is an isometric view of a disc drive 100, in which embodiments of the present invention are useful. Disc drive 100 includes a housing with a base 102 and a top cover (not shown). Disc drive 100 includes multiple discs 106 that are mounted for rotation by a motor (not shown) by a disc media retainer 108, in accordance with the present invention. Disc head sliders 110 are mounted to disc drive 100 for communication with the surfaces of each disc 106. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot 1 shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

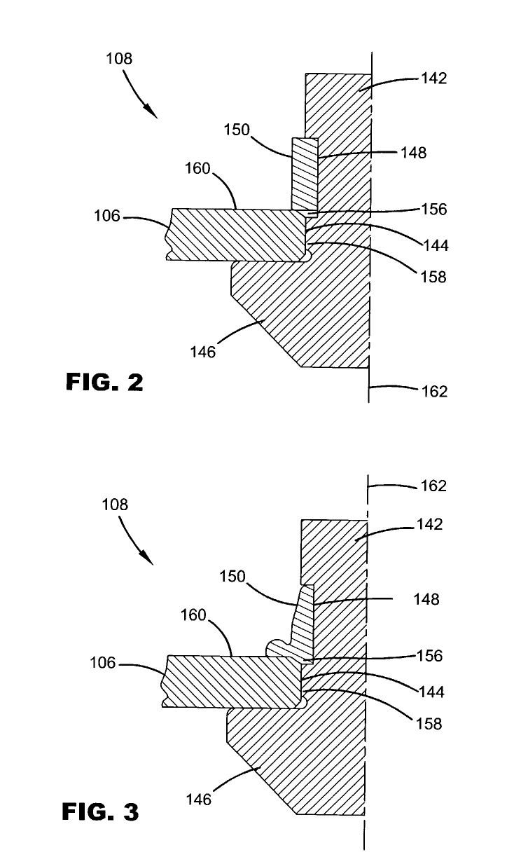

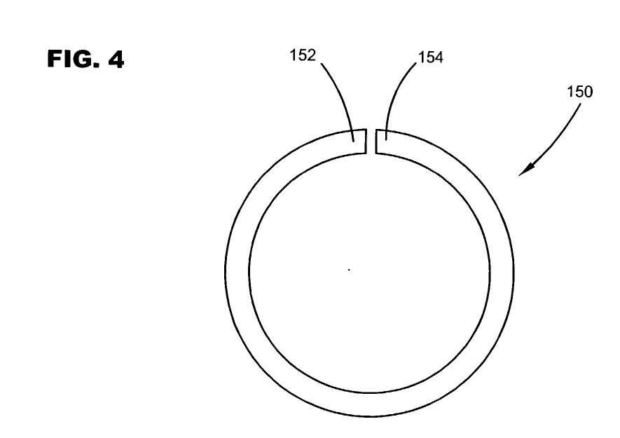

FIGS. 2 and 3 are enlarged side cross-sectional views illustrating the disc retainer 108 of the present invention for of securing a disc 106 to a hub member 142, in accordance with an embodiment of the invention. Disc 106 includes an interior edge 144 defining a central opening that surrounds a portion of hub member 142. Disc hub member 142 includes an annular flange 146, on which disc 106 is supported. In accordance with one embodiment of the invention, hub member 142 also includes an annular groove 148 as shown in FIG. 2. A retaining ring 150 surrounds hub member 142 adjacent annular groove 148 and interior edge 144 of disc 106. Retaining ring 150 is preferably formed of plastic. One embodiment of retaining ring 150 is a split ring, such as that shown in FIG. 4, having ends 152 and 154 that can be separated to allow retaining ring 150 to be placed in the desired position adjacent annular groove 148. In accordance with another embodiment of the invention, retaining ring 150 is a solid ring that can be heated and stretched, if necessary, to allow its placement over hub member 142 into the desired position where it is allowed to cool. Retaining ring 150 has an interior diameter that is preferably slightly less than an exterior diameter of hub member 142. This ensures that retaining ring 150 will conform to the exterior surface of cylindrical portion 143 and be retained within annular groove 148.

The central opening of disc 106 has a diameter that is slightly larger than an outer diameter of hub member 142 to allow for easy placement thereon. Accordingly, a radial gap 156 exists between interior edge 144 of disc 106 and hub member 142. Hub member 142 can also include a radial spacer ring 158 that is positioned between annular flange 146 and annular groove 148, and is radially aligned with a portion of interior edge 144 of disc 106.

As illustrated in FIG. 3, retaining ring 150 is swaged within annular groove 148 and gap 156 between interior edge 144 of disc 106 and hub member 142. Additionally, retaining ring 150 is swaged over a top surface 160 of disc 106 adjacent interior edge 144. This swaging process causes retaining ring 150 to undergo plastic deformation, which permanently changes its shape. During the swaging of retaining ring 150, pressure is applied to retaining ring 150 and disc 106 to ensure disc 106 is securely engaging annular flange 146. Retaining ring 150 prevents disc 106 from moving in an axial direction (defined by axis 162) since retaining ring 150 is fixed in the axial direction due to the swaging of it within annular groove 148. Disc 106 is also prevented from moving in a radial direction relative to hub member 142 due to the swaging of retaining ring 150 within radial gap 156 between interior edge 144 of disc 106 and hub member 142. Additionally, relative rotational movement between disc 106 and hub member 142 is prevented due to frictional resistance between retaining ring 150 and disc 106. Once the swaging of retaining ring 150 is complete, the components are allowed to reach an equilibrium state in which relatively little force is applied to disc 106 to secure disc 106 to hub member 142 and, as a result, the disc deformation problems associated with prior art disc clamps are avoided.

The swaging of retaining ring 150 is preferably conducted using an ultrasonic horn that is annularly shaped and sized to surround hub member 142 such that it can be placed on retaining ring 150. Alternatively, the swaging of retaining ring 150 can be conducted using a heat staking process where retaining ring 150 is heated and subsequently allowed to cool after it is permanently transformed by plastic deformation into the desired position and shape. Other suitable techniques can also be implemented to perform the desired swaging of retaining ring 150.

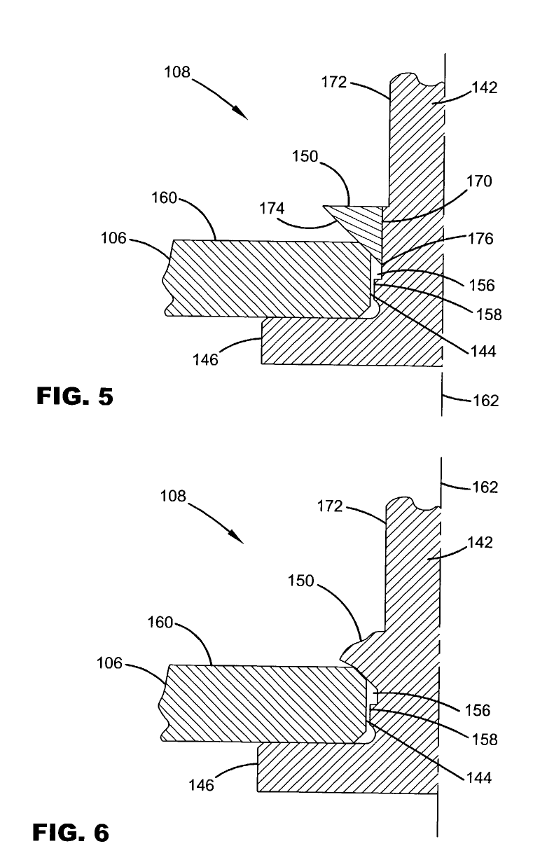

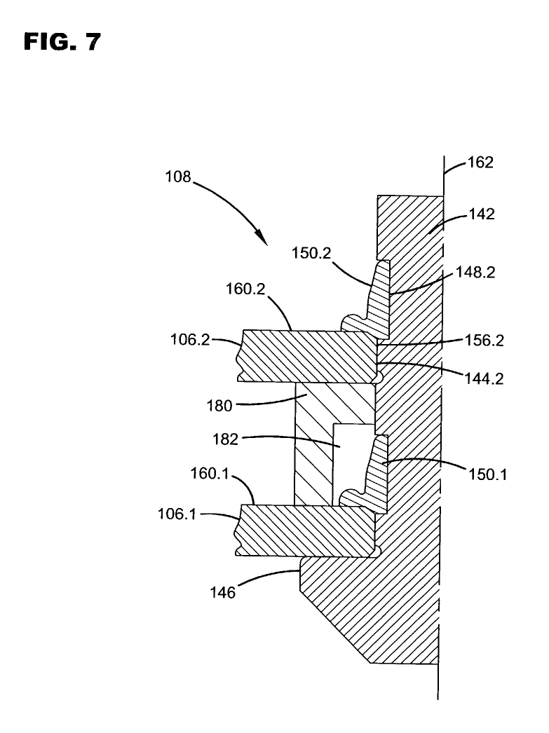

FIGS. 5 and 6 illustrate a method of securing a disc 106 to a plastic hub member 142 in accordance with another embodiment of the invention. In accordance with this embodiment, retaining ring 150 includes an interior surface 170 adjoining an exterior surface 172 of disc hub member 142, and a beveled surface 174 extending outwardly from disc hub member 142 from a bottom edge 176. As with the embodiment discussed above, retaining ring 150 can be a split ring (FIG. 4) or a continuous ring that is either slid over disc hub member 142 or heated and expanded to fit over disc hub member 142. Beveled portion 174 of retaining ring 150 is initially positioned in contact with disc 106 such that a portion of retaining ring 150 is wedged within radial gap 156 between interior edge 144 of disc 106 and exterior surface 172 of hub member 142, as shown in FIG. 5. Next, interior surface 170 of retaining ring 150 is ultrasonically welded to exterior surface 172 of disc hub member 142. In addition, the portion of retaining ring 150 overhanging disc 106 is swaged to engage top surface 160 of disc 106, as shown in FIG. 6. Disc 106 is thereby prevented from moving in axial and radial directions relative to hub member 142. Furthermore, disc 106 is secured to hub member 142 without having to apply significant clamping forces that could cause it to become warped.

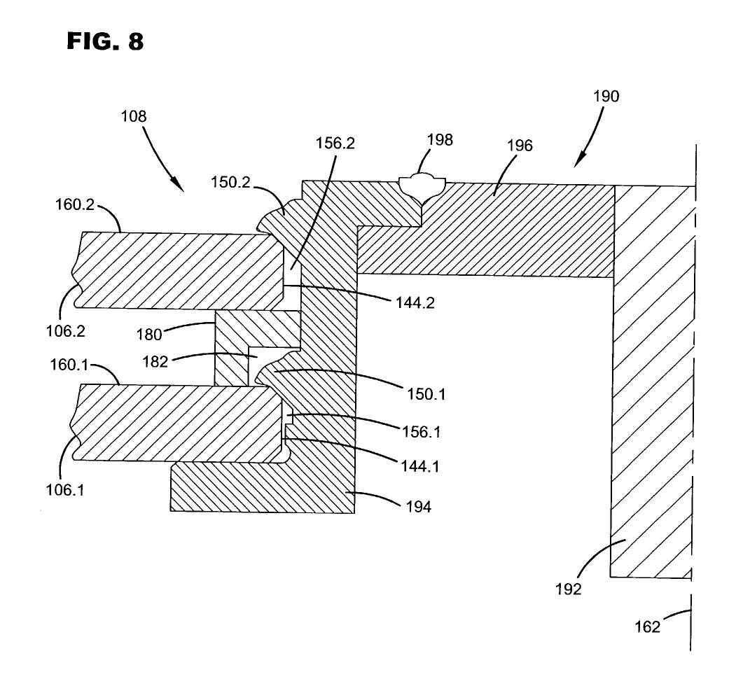

FIGS. 7 and 8 are enlarged side cross-sectional views illustrating disc media retainers 108 that configured to support multiple discs in accordance with various embodiments of the invention. In FIG. 7, a first disc 106.1 is supported in accordance with the disc media retainer 108 of FIGS. 2 and 3. An annular spacer ring 180 surrounds hub member 142 and engages top surface 160 of first disc 106.1. Annular spacer ring 180 includes an annular groove 182 that is sized to accommodate first retaining ring 150.1. A second disc 106.2 having a central opening defined by interior edge 144.2 is supported on annular spacer ring 180. A second retaining ring 150.2 is swaged within a second annular groove 148.2 and a radial gap 156.2 between an interior edge 144.2 of second disc 106.2 and disc hub member 142. Second retaining ring 150.2 is further swaged over a top surface 160.2 of second disc 106.2 adjacent to interior edge 144.2. First and second discs 106.1 and 106.2 are thus secured to disc hub member 142 and prevented from moving both radially and axially relative to disc hub member 142. Additional discs 106 can be secured to disc hub member 142 in the manner discussed above using additional spacer members 180 and retaining rings 150.

In FIG. 8, a first disc 106.1 is supported in accordance with the disc media retainer 108 of FIGS. 5 and 6. As above, an annular spacer ring 180 surrounds hub member 142 and engages top surface 160.1 of first disc 106.1. Annular spacer ring 180 includes an annular groove 182 that is sized to accommodate first retaining ring 150.1. A second disc 106.2 having a central opening defined by interior edge 144.2 is supported on annular spacer ring 180. A second retaining ring 150.2 is wedged within a radial gap 156.2 between an interior edge 144.2 of second disc 106.2 and disc hub member 142 and is welded to disc hub member 142. Second retaining ring 150.2 is also swaged over a top surface 160.2 of second disc 106.2 adjacent to interior edge 144.2. First and second discs 106.1 and 106.2 are thus secured to disc hub member 142 and prevented from moving both radially and axially relative to disc hub member 142. Additional discs 106 can be secured to disc hub member 142 in the manner discussed above using additional spacer members 180 and retaining rings 150.

FIG. 8 also depicts disc media retainer 108 as a disc pack assembly 190 where disc hub member 142 is configured as a primary support for discs 106.1 and 106.2 and is mounted to a rotatable spindle hub or bearing cartridge 192 of a disc drive or external servo writer. The attachment to spindle hub 192 can be made directly by appropriately sizing an interior diameter 194 of disc hub member 142 such that it can receive the rotatable spindle 192 and can then be secured for co-rotation therewith using an adhesive or other conventional means. In accordance with one embodiment, disc pack assembly 190 is secured to spindle hub 192 through a plastic or metal hub web 196. Hub web 196 can be attached to disc hub member 142 by an adhesive or an ultrasonic weld as indicated at 198, or other suitable means.

Alternatively described, the present invention is directed to a disc retainer (such as 108) that generally includes a hub member (such as 142), a first disc (such as 106 or 106.1) having a central opening defined by an interior edge (such as 144) surrounding the hub member, and a first retaining ring (such as 150 or 150.1). The hub member could be a rotatable spindle hub of a disc drive or servo writer (such as 192) or a primary supporting component of a disc pack assembly (such as 190). In accordance with one embodiment of the invention, the disc hub member includes an annular flange (such as 146) and an annular groove (such as 148). The first disc is supported on the annular flange. The first retaining ring is swaged within the annular groove and a radial gap (such as 156) between the hub member and the interior edge of the disc, and over a top surface (such as 160) of the disc adjacent to the interior edge. The retaining ring is preferably formed of plastic and can be either a split ring having separable ends (such as 152 and 154), or a solid ring. The hub member can also include a radial spacer ring (such as 158) between the annular groove and the annular flange and radially aligned with a portion of the interior edge of the disc.

A multi-disc embodiment of the disc media retainer further includes an annular spacer member (such as 180) surrounding the hub member and engaging the top surface of the first disc (such as 106.1) and includes an annular groove (such as 182) that is sized to accommodate the first retaining ring. A second disc (such as 106.2) having a central opening defined by an interior edge (144.2) surrounds the hub member and is supported on the spacer member. A second retaining ring (such as 150.2) is swaged within a radial gap (such as 156.2) between the interior edge of the second disc and the disc hub member, and over a top surface (160.2) of the second disc adjacent to the interior edge.

In accordance with another embodiment of the invention, the disc media retainer includes a disc hub member (such as 142) having an annular flange (such as 146) extending radially therefrom, a first disc (such as 106.1) supported on the annular flange and having a central opening defined by an interior edge (such as 144) surrounding the disc hub member. A first retaining ring (such as 150.1) is wedged within a radial gap (such as 156) between the disc hub member and the interior edge of the disc, welded to the disc hub member, and swaged over a top surface (such as 160) of the disc adjacent the interior edge. One embodiment of the retaining ring includes an interior surface (such as 170) adjoining an exterior surface (such as 172) of the disc hub member and a beveled surface (such as 174) extending outwardly from the disc 25 hub member from a bottom edge (such as 176).

In accordance with a multi-disc embodiment of the invention, an annular spacer member (such as 180) surrounds the disc hub member and engages a top surface (such as 160.1) of the first disc and includes an annular groove (such as 182) that is sized to accommodate the first retaining ring (such as 150.1). A second disc (such as 106.2) having a central opening defined by an interior edge (such as 144.2) surrounds the disc hub member and is supported on the spacer member. A second retaining ring (such as 150.2) is wedged within a radial gap (such as 156.2) between the disc hub member and the interior edge of the second disc, welded to the disc hub member, and swaged over a top surface (such as 160.2) of the second disc.

For the disc pack assembly embodiment of the invention, the disc hub member can be mounted to a rotatable spindle hub (such as 192) of a disc drive or servo writer either by direct connection or through a spindle hub web (such as 196).

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the disc media retainer while maintaining substantially the same functionality without departing from the scope of the present invention.

What is claimed is:

1. A disc media retainer comprising:
a disc hub member having an annular flange and an annular groove;
a first disc having a central opening defined by an interior edge surrounding the spindle hub, the disc being supported on the annular flange; and
a first retaining ring swaged within the annular groove and a radial gap between the hub member and the interior edge of the disc, and over a top surface of the disc adjacent the interior edge.

2. The disc media retainer of claim 1, wherein the hub member includes a radial spacer ring between the annular groove and the annular flange and radially aligned with a portion of the interior edge of the first disc.

3. The disc media retainer of claim 1, wherein the first retaining ring is formed of plastic.

4. The disc media retainer of claim 1, wherein the first retaining ring is a split ring.

5. The disc media retainer of claim 1 including:
an annular spacer member surrounding the hub member and engaging the top surface of the first disc, the spacer member including an annular groove sized to accommodate the first retaining ring;
a second disc having a central opening defined by an interior edge surrounding the hub member, the second disc being supported on the spacer member; and
a second retaining ring swaged within a second annular groove and a radial gap between the second annular groove and the interior edge of the second disc, and over a top surface of the second disc adjacent the interior edge.

6. A disc media retainer comprising:
a disc hub member having an annular flange extending radially therefrom;
a first disc having a central opening defined by an interior edge surrounding the disc hub member, the first disc being supported on the annular flange; and
a first retaining ring wedged within a radial gap between the disc hub member and the interior edge of the first disc, welded to the disc hub member and swaged over a top surface of the disc adjacent the interior edge.

7. The disc media retainer of claim 6, wherein the disc hub member includes a radial spacer ring that is radially aligned with a portion of the interior edge of the first disc.

8. A disc drive or servo writer including:
a rotatable spindle hub;
a motor configured to rotate the spindle hub; and
the disc media retainer of claim 6 mounted to the spindle hub at the disc hub member.

9. The disc media retainer of claim 8 including a hub web member joining the disc hub member to the spindle hub.

10. The disc media retainer of claim 6, wherein the retaining ring is formed of plastic.

11. The disc media retainer of claim 6, wherein the retaining ring is a split ring.

12. The disc media retainer of claim 6, wherein the retaining ring includes an interior surface adjoining an exterior surface of the disc hub member and a beveled surface extending outwardly from the disc hub member from a bottom edge.

13. The disc media retainer of claim 6 including:
an annular spacer member surrounding the disc hub member and engaging the top surface of the first disc, the spacer member including an annular groove sized to accommodate the first retaining ring;
a second disc having a central opening defined by an interior edge surrounding the disc hub member, the second disc being supported on the spacer member; and
a second retaining ring wedged within a radial gap between the disc hub member and the interior edge of the second disc, welded to the disc hub member and swaged over a top surface of the second disc adjacent the interior edge.

14. A disc media retainer comprising:
a disc hub member having an annular flange;
a disc supported on the annular flange and having an interior edge; and
disc retaining means for radially and axially securing the disc to the disc support.

15. The disc media retainer of claim 14, wherein:
the disc hub member includes an annular groove; and
the disc retaining means includes a retaining ring swaged within the annular groove and a radial gap between the disc hub member and the interior edge of the disc, and over a top surface of the disc adjacent the interior edge.

16. The disc media retainer of claim 15, wherein the retaining ring is a split ring.

17. The disc media retainer of claim 14, wherein the disc retaining means includes a retaining ring wedged within a radial gap between the disc hub member and the interior edge of the disc, welded to the disc hub member and swaged over a top surface of the disc adjacent the interior edge.

18. The disc media retainer of claim 17, wherein the retaining ring includes an interior surface adjoining an exterior surface of the disc hub member and a beveled surface extending outwardly from the disc hub member from a bottom edge.

19. The disc media retainer of claim 17, wherein the retaining ring is a split ring.

20. A disc drive or servo writer including:
a rotatable spindle hub;
a motor configured to rotate the spindle hub; and
the disc media retainer of claim 14 mounted to the spindle hub at the disc hub member.
